(19) United States
(12) Patent Application Publication
(10) Pub. No.: US 2012/0118827 A1
(43) Pub. Date: May 17, 2012

(54) METHOD OF CONCENTRATING LOW TITER FERMENTATION BROTHS USING FORWARD OSMOSIS

(75) Inventors: Ho Nam CHANG, Daejeon (KR); Jin-dal-rae CHOI, Daejeon (KR); Sang Yup LEE, Daejeon (KR); Jeong Wook LEE, Daejeon (KR); Sunwon PARK, Daejeon (KR); Woohyun KIM, Woolsan (KR); Tae-woo KIM, Buchen-si (KR); Kwonsu JUNG, Gwangju (KR); Gwon-woo PARK, Mokpo-si (KR); Wanji KONG, Busan (KR); Sung Gap IM, Daejeon (KR)

(73) Assignee: KOREA ADVANCED INSTITUTE OF SCIENCE AND TECHNOLOGY, Daejeon (KR)

(21) Appl. No.: 13/294,040

(22) Filed: Nov. 10, 2011

(30) Foreign Application Priority Data
Nov. 11, 2010 (KR) 10-2010-0112241

(51) Int. Cl. B01D 61/00

(52) U.S. Cl. 210/650

(57) ABSTRACT

The present invention relates to a method for concentrating law titer fermentation broth, and more particularly to a method for concentrating a fermentation broth using forward osmosis. The method comprises: introducing the fermentation broth and an osmolyte into a feed chamber and a draw chamber, respectively, which are included in a concentration system and are divided from each other by a forward osmosis membrane, and subjecting the introduced fermentation broth to forward osmosis, thereby concentrating the fermentation broth in the feed chamber. The method can maximize the concentration of the low titer fermentation broth while minimizing energy consumption and operating cost, and thus can contribute to the industrialization of new technology.

### BACKGROUND OF THE INVENTION

1. Field of the Invention

The present invention relates to a method for concentrating a fermentation broth, and more particularly to a method for concentrating low titer fermentation broth using forward osmosis.

2. Background of the Related Art

Various products that enrich human life are produced mainly by the industrial fermentation of microorganisms. These products include: (a) microbial cells (single cell proteins, bread proteins, lactic acid bacterial cells, E. coli cells, and in vivo proteins/non-proteins contained in these microbial cells (polyhydroxybutyric acid, biological lipid, etc.)), (b) primary metabolites (ethanol, butanol, citric acid, lactic acid, acetic acid, succinic acid, various amino acids and vitamins, etc.), (c) secondary products (antibiotics), (d) a variety of secreted proteins (enzymes, including amylase and cellulose, and proteins, including insulin interferon and monoclonal antibodies, etc.), (e) a variety of biotransformations (steroids).

The most important factors in the fermentation processes are product concentration and productivity. In fermentation processes, nutrient broths containing carbon sources, such as glucose, sucrose, etc., nitrogen sources, vitamins, and trace minerals are introduced into bioreactors containing microorganisms, in which they are fermented by a batch, fed-batch, continuous, or high-cell-density continuous fermentation process, etc., thereby providing high-concentration fermentation products.

At present, in the industrial filed, a batch-fed fermentation is most frequently used to produce high-concentration fermentation products. It is operated in a batch manner at the initial stage, and then high-concentration nutrient broths are fed such that microorganisms do not undergo substrate inhibition, thereby maximizing the concentration of the product. In general, the concentration of a product ultimately reaches a limit since the product itself inhibits the physiological activity of microorganisms. For example, ethanol is produced at a concentration of 90 g/L and lactic acid at a concentration of 180 g/L, but volatile fatty acid such as acetic acid is produced at a low concentration of about 30 g/L from glucose as a raw material. Herein, the concentration of 90 g/L indicates that the amount of the product is 90 g and the amount of water is 910 g. Also, the concentration of 180 g/L indicates that the amount of water is 820 g, and the concentration of 30 g/L indicates that the amount of water is 970 g.

The amount of water to be removed per g of product is 10.1 g/g-ethanol, 4.5 g/g-lactic acid, and 32.3 g/g-acetic acid. The quantity of heat required to remove 1 g of water at 30° C. by evaporation/distillation is 629 cal. When the amount of water to be removed per kg of fermentation product is expressed as kwh, it is 3.2 kwh/kg of lactic acid, 7.3 kwh/kg of ethanol, and 23.5 kwh/kg of acetic acid. However, heat can be used repeatedly several times, and thus when it is used four times, the amount of water which is removed is 0.8 kwh/kg of lactic acid, 1.8 kwh/kg of ethanol, and 5.8 kwh/kg of acetic acid. Currently, it is known that the amount of energy needed to produce 1 m³ of desalinated water in a seawater desalinating process is 25 kwh. The amount of energy needed to evaporate 1 ton of water to steam at a temperature of 30-100° C. is 2.629×10⁹ J corresponding to 730 kwh (1 kwh=3.6×10⁶J). If an amount of energy of 25 kwh is used to evaporate 1 ton of water through an efficient distillation process, it shows the efficiency at which heat is used about 29 times, based on the first law of thermodynamics (the law of conservation of energy). Although this efficient process requires a large equipment investment, it has advantages in that, as the concentration of a product increases, the productivity of a bioreactor increases and the cost for removing water per unit weight of product decreases.

An asymmetric reverse osmosis membrane was developed by Loeb-Sourirajan in 1958, and a reverse osmosis process employing this reverse osmosis membrane was first used in 1960 to desalinate seawater. On the other hand, a forward osmosis process that uses a difference in concentration to produce energy was also first proposed by Loeb-Sourirajan in 1976 (Loeb, S, Loeb-Sourirajan Membrane, How it Came About Synthetic Membranes, ACS Symposium Series 153, ch 1, pp 1-9 (1981); Loeb, S., J. Membr. Sci 1, 49, (1976)). The flow of water through a membrane in the reverse and forward osmosis processes is expressed by the following equation (1):

Jv=A(Δπ−ΔP) (1)

wherein Jv: the volume of water permeated per unit membrane area (m³/(h.m²atm); A: membrane area (m²), Δπ: difference in osmotic pressure (atm); and ΔP: difference in head pressure (atm).

ΔP>Δπ indicates reverse osmosis (RO), and Δπ>ΔP indicates forward osmosis (FO). In the forward osmosis process, a sample to be concentrated is filled in a feed chamber, and either NaCl having a high osmotic pressure, or ammonium carbamate that is easily recyclable after use is filled in a draw chamber. In the case of seawater desalination, the forward osmosis process differs from the reverse osmosis process in that pressure is applied to the left chamber and NaCl-free water can be obtained directly from the right chamber. The process of desalinating seawater by forward osmosis is performed in the following manner. When a solution having a pressure higher than that of a solution in the right chamber, for example, an ammonium carbamate solution, is supplied to the left chamber, pure water moves from the left chamber to the right chamber due to the difference in osmotic pressure between the two solutions, and then the ammonium carbamate is recycled and pure water is collected as a product (McCutcheon J R, McGuinnis R L, Elimelech R L, Desalination 174, 1-11 (2005).

In a process of concentrating a fermentation broth, a sample in the left chamber is concentrated by forward pressure, and a material having a high osmotic pressure, such as NaCl, can be used in the right chamber. Examples in which a solution in the right chamber is concentrated by forward osmosis include sludge leachate concentration (York, R. J. et al, '99 Seventh International Waste Management and Landfill Symposium, Sardina, Italy, 1999), fruit juice concentration (Beauty, E. J., Lampi K. A., Food Technology, 44,121, 1999), etc., but the concentration of a fermentation broth in the right chamber has not yet been reported.

Fermentation broths include various products having molecular weights ranging from several tens to several tens of thousands, such as ethanol and acetic acid.

For forward osmosis (FO), a membrane that is permeable to water only is used, but membranes for nanofiltration (NF), ultrafiltration (UF), or microfiltration (MF) may also be used for concentration of fermentation products. This is because the use of such membranes is possible when using a material that does not move from the right draw chamber to the left feed chamber and, at the same time, can exhibit a significant osmotic pressure. In this case, like the case of protein concentration, materials having smaller molecular weights, together with water, can be moved from the left side to the right side, so that they can be purified.

Methods that are currently used to concentrate and purify such fermentation products include distillation, solvent extraction, and precipitation, and the like. However, energy, solvents, extraction solvents, and the like which are used in these methods are highly expensive, and thus it is uneconomical to concentrate fermentation products using these methods.

Accordingly, the present inventors have made extensive efforts to solve the above-described problems and, as a result, have found that, when the fermentation broth and an osmolyte are introducing into a feed chamber and a draw chamber, respectively, which are included in a concentration system and are divided from each other by a forward osmosis membrane, and then the fermentation broth is subjected to forward osmosis to thereby concentrate the fermentation broth in the feed chamber, the concentration of the fermentation broth can be maximized while minimizing energy consumption and operating cost, thereby completing the present invention.

### SUMMARY OF THE INVENTION

Accordingly, it is an object of the present invention to provide a method for concentrating a variety of fermentation broths, which can maximize the concentration of the fermentation broths while minimizing energy consumption and operating cost.

To achieve the above object, the present invention provides a method of concentrating a fermentation broth using forward osmosis, the method comprising: introducing the fermentation broth and an osmolyte into a feed chamber and a draw chamber, respectively, which are included in a concentration system and are divided from each other by a forward osmosis membrane, and subjecting the introduced fermentation broth to forward osmosis, thereby concentrating the fermentation broth in the feed chamber.

In the present invention, the forward osmosis membrane may be permeable to water or a material having a molecular weight lower than that of a material to be concentrated, which is contained in the fermentation broth in the feed chamber, such that the water or lower molecular weight material is transferred to the draw chamber.

In the present invention, the fermentation broth may comprise a material selected from the group consisting of microorganisms, microbial primary metabolites, microbial secondary metabolites, secreted microbial proteins, microbial biotransformations, plant cells, animal cells, and mixtures thereof.

In the present invention, the osmolyte may be selected from the group consisting of an NaCl-containing solution, an ammonia carbamate-containing solution, a waste solution having a high osmotic pressure, and an MgCl₂-containing solution.

In the present invention, the forward osmosis may be performed by a process selected from the group consisting of a batch process, a continuous process and a pressure process using external pressure, wherein the batch process corresponds to a state in which the feed chamber and the draw chamber are in equilibrium with each other, the continuous process corresponds to a state in which the difference in water pressure between the two chamber is eliminated, and the pressure process using external pressure comprises applying a pressure to the feed chamber or applying a vacuum to the draw chamber to cause a difference in pressure between the two chambers.

In the present invention, the batch process may be performed until the difference in head pressure (ΔP) is equal to the difference in osmotic pressure (Δπ), the continuous process may be performed until an equilibrium state is reached in which the difference in head pressure (ΔP) becomes zero and the difference in osmotic pressure (Δπ) becomes zero, and the pressure process using external pressure may be performed until the difference in pressure induced by applying external pressure (ΔPex) is equal to the difference in osmotic pressure (Δπ).

In the present invention, each of the feed chamber and the draw chamber may consist of multiple stages.

In the present invention, the fermentation broth may have a pH of 2-13 and a temperature of about 0-100° C. in which water is maintained in the liquid state. The temperature of the fermentation broth may vary if the fermentation broth contains compounds such as alcohol or if pressure is applied thereto. The osmolyte may be progressively introduced into the draw chamber to efficiently maintain the difference in osmotic pressure between the feed chamber and the draw chamber.

In the present invention, after the forward osmosis has been performed, the osmolyte in the draw chamber may be transferred to a solute regeneration system in which it is in turn regenerated for reuse.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view showing a method of concentrating a fermentation broth using forward osmosis according to one embodiment of the present invention;

FIG. 2 is a schematic view showing the degree of concentration (first equilibrium state) according to one embodiment of the present invention;

FIG. 3 is a schematic view showing the degree of concentration (second equilibrium state) according to one embodiment of the present invention;

FIG. 4 is a schematic view showing the degree of concentration (third equilibrium state) according to one embodiment of the present invention;

FIG. 5 is a graphic diagram showing the changes in solution concentration and volume during an osmosis process as a function of time; and

FIG. 6 illustrates a multiple-stage operation according to one embodiment of the present invention.

### DETAILED DESCRIPTION OF THE PREFERRED EMBODIMENTS

Now, the preferred embodiments of the present invention will be descried hereinafter in more detail with reference to the accompanying drawings.

Based on the fact that the amount of energy required to desalinate seawater using forward osmosis is only 10-20% of the energy required to desalinate seawater using conventional reverse osmosis or various distillation processes, the present inventors predicted that the concentration of various fermentation products using forward osmosis would be highly economical.

In addition, based on the above prediction, the present inventors predicted that, if the degree and rate of concentration of a fermentation broth are reasonably established for the economical operation of forward osmosis, the forward osmosis process can be advantageously used in industrial applications.

In one embodiment of the present invention, an acetic acid-containing fermentation broth and NaCl were introduced into a feed chamber and a draw chamber, respectively, which were included in a concentration system and divided from each other by a forward osmosis membrane, after the fermentation broth in the feed chamber was subjected to forward osmosis. As a result, it was found that the acetic acid in the feed chamber was concentrated.

Accordingly, in one aspect, the present invention is directed to a method of concentrating a fermentation broth using forward osmosis, the method comprising: introducing the fermentation broth and an osmolyte into a feed chamber and a draw chamber, respectively, which are included in a concentration system and are divided from each other by a forward osmosis membrane, and subjecting the introduced fermentation broth to forward osmosis, thereby concentrating the fermentation broth in the feed chamber.

The time of concentration is determined by the properties of the forward osmosis membrane and the area of the membrane, and thus the use of a hollow fiber membrane can ensure economic efficiency, because it can increase the area of a membrane module, thereby significantly reducing the time of concentration.

FIG. 1 is a schematic view showing a method of concentrating a fermentation broth using forward osmosis according to one embodiment of the present invention.

As shown in FIG. 1, a forward osmosis membrane 20 is preferably permeable to water or a material having a molecular weight lower than that of a material to be concentrated, which is contained in the fermentation broth in a feed chamber 10, such that the water or the lower molecular weight material is transferred to a draw chamber 30. In other words, the forward osmosis membrane is made of a material which is permeable to water or lower molecular weight materials of the fermentation broth, but is impermeable to a material to be concentrated or an osmolyte. If the molecular weight of the material to be concentrated is 1000 or less, a reverse osmosis membrane (permeable only to water) or a nanofiltration membrane (permeable only to NaCl) may be used, and if the material to be concentrated is a protein having a molecular weight ranging from several thousands to several tens of thousands, an ultrafiltration membrane (permeable to a material having a molecular weight ranging from several thousands to several tens of thousands) may be used.

In the present invention, examples of the fermentation broth may include, but are not limited to, microorganisms, microbial primary metabolites, microbial secondary metabolites, secreted microbial proteins, microbial biotransformations, plant cells, animal cells, and mixtures thereof.

In other words, the method of concentrating the fermentation broth using forward osmosis according to the present invention may be applied to, in addition to the fermentation broth, products which show molecular weights and properties similar to those of the fermentation broth and have low concentrations and from which water preferably needs to be removed.

As the microorganism, any microorganism may be used without particular limited in the present invention, so long as it is involved in fermentation. Examples thereof include bacteria (E. coli), yeasts (S. cerevisiae), animal cells (CHO), plant cells, etc.

Examples of the microbial primary metabolites include, but are not limited to, volatile fatty acids (acetic acid, propionic acid, butyric acid, lactic acid, citric acid, succinic acid, etc.), alcohols (ethanol, butanol, etc.), nucleic acids, amino acids (lysine, tryptophan, etc.), vitamins, polysaccharides and the like.

Examples of the microbial secondary metabolites include, but are not limited to, antibiotics (penicillin, etc.), enzyme inhibitors, physiologically active substances (Taxol, etc.). Examples of the excreted microbial proteins include, but are not limited to, enzymes such as amylase and cellulose, insulin, interferon, monoclonal antibodies, etc. The biotransformations are substances produced using microorganisms or enzymes and may be exemplified by, but not limited to, steroids.

In the present invention, the osmolyte may be selected from the group consisting of an NaCl-containing solution, an ammonia carbamate-containing solution, a waste solution having a high osmotic pressure, and an MgCl₂-containing solution. The waster solution having a high osmotic pressure may be seawater concentrated to about 1/10, which results from seawater desalination plants.

The ammonia carbamate has advantages in that it has a high osmotic pressure (2M) and is regenerated without undergoing phase transformation. The sodium chloride (NaCl) can be easily obtained from seawater (having a NaCl concentration of about 3% at 26 atm) in the most economical manner. For example, NaCl can be economically by either evaporating water from seawater using air or concentrating seawater using solar heat.

In the present invention, the forward osmosis process may be carried out by a process selected from the group consisting of a batch process, a continuous process, and a process using external pressure, in order to maximize the effect thereof.

The batch process corresponds to a case in which the two chambers are not in flow communication with external systems. The continuous process corresponds to a case in which the two chambers are in flow communication with external systems. Also, the pressure process using external pressure comprises by applying a pressure to the feed chamber or applying a vacuum to the draw chamber to cause a difference in pressure between the two chambers.

In the present invention, the batch process is performed until the difference in head pressure (ΔP) is equal to the difference in osmotic pressure (Δπ), the continuous process is performed until an equilibrium state is reached in which the difference in head pressure (ΔP) becomes zero and the difference in osmotic pressure (Δπ) becomes zero, and the pressure process using external pressure is performed until the difference in pressure induced by applying external pressure (ΔPex) is equal to the difference in osmotic pressure (Δπ).

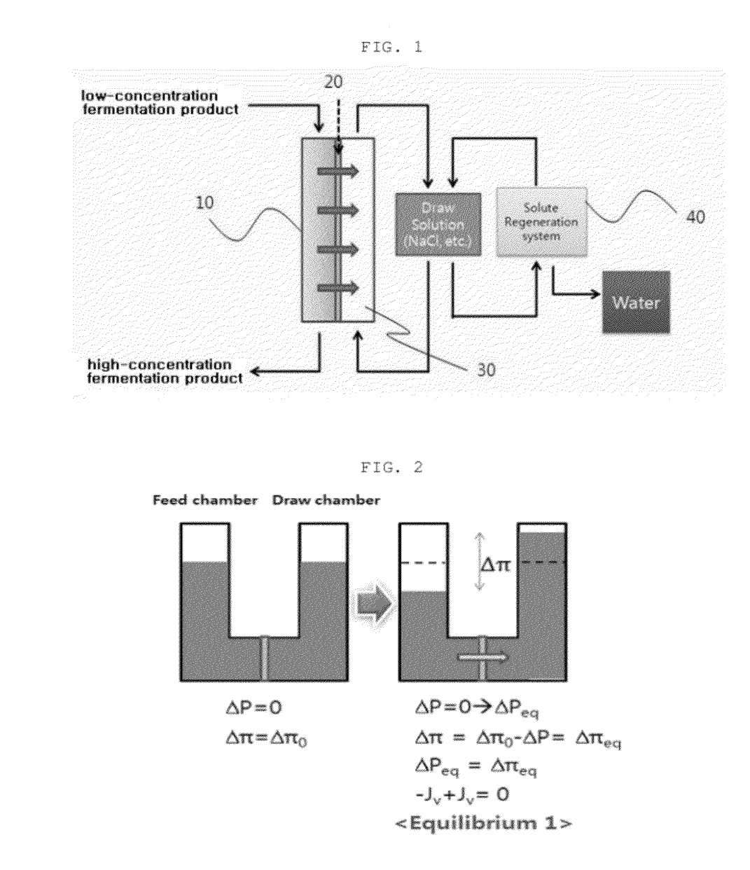

Hereinafter, the present invention will be described in further detail with reference to the accompanying drawings. FIGS. 2 to 4 are views showing the degrees of concentration according to one embodiment of the present invention and show a first equilibrium state, a equilibrium state and a third equilibrium state, respectively.

In a batch operation, the equilibrium between the solution in the feed chamber and the solution in the draw chamber is predicted from the following theory. In the initial stage of forward osmosis, there is no difference in head pressure between the feed chamber and the draw chamber, indicating ΔP=0 and Δπ=Δπ₀. However, as the forward osmosis (FO) progresses, water in the feed chamber moves toward the draw chamber, so that the concentration of the solute in the feed chamber increases and the osmotic pressure in the feed chamber also increases. Meanwhile, the water level of the draw chamber rises (that is, the water level of the draw chamber becomes higher than that of the feed chamber) while the difference in head pressure (ΔP) starts to increase. ΔP interferes with the movement (Jv) of water from the feed chamber to the draw chamber. Also, the osmotic pressure of the draw chamber starts to decrease, and after a long time, the flux of water between the two chambers reaches equilibrium (see FIG. 2).

Meanwhile, in a continuous operation, the equilibrium between the solution in the feed chamber and the solution in the draw chamber is predicted from the following theory.

The water levels of the two chambers are made equal to each other such that ΔP in the draw chamber does not occur. Then, additional forward osmosis (FO) occurs due to Δπ. When ΔP=0 and Δπ=0 are reached, a second equilibrium state is reached. Of course, the degree of concentration in the feed chamber will be higher than that in the first equilibrium state (see FIG. 3).

Meanwhile, in an operation using external pressure, the equilibrium between the solution in the feed chamber and the solution in the draw chamber is predicted from the following theory.

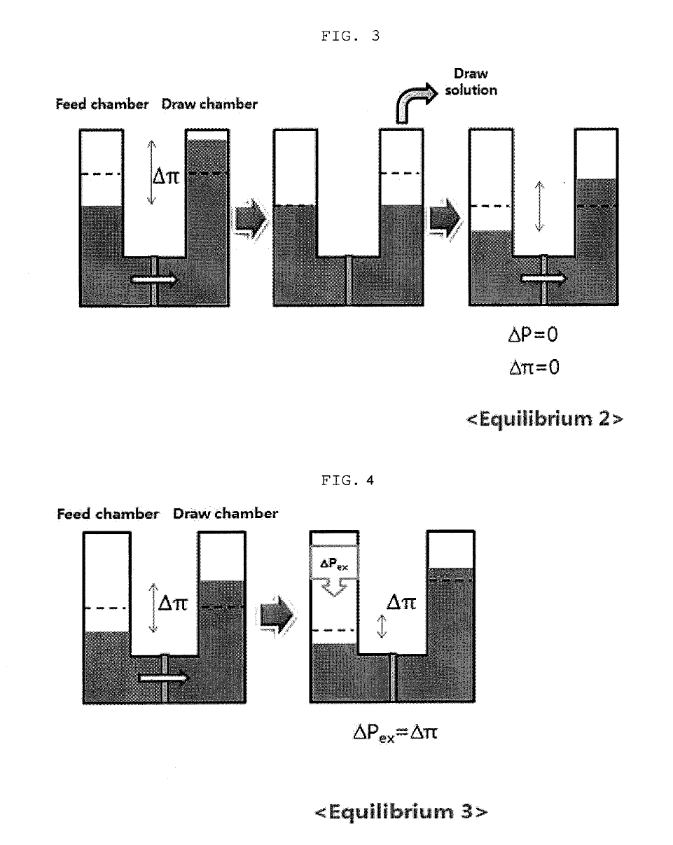

Specifically, a vacuum is applied to the draw chamber or pressure is applied to the feed chamber, thereby causing external pressure (ΔPₑₓ). Then, additional forward osmosis (FO) occurs due to Δπ. When ΔPₑₓ is equal to Δπ, a third equilibrium state is reached. Of course, the degree of concentration in the feed chamber will be higher than that in the second equilibrium state (see FIG. 4).

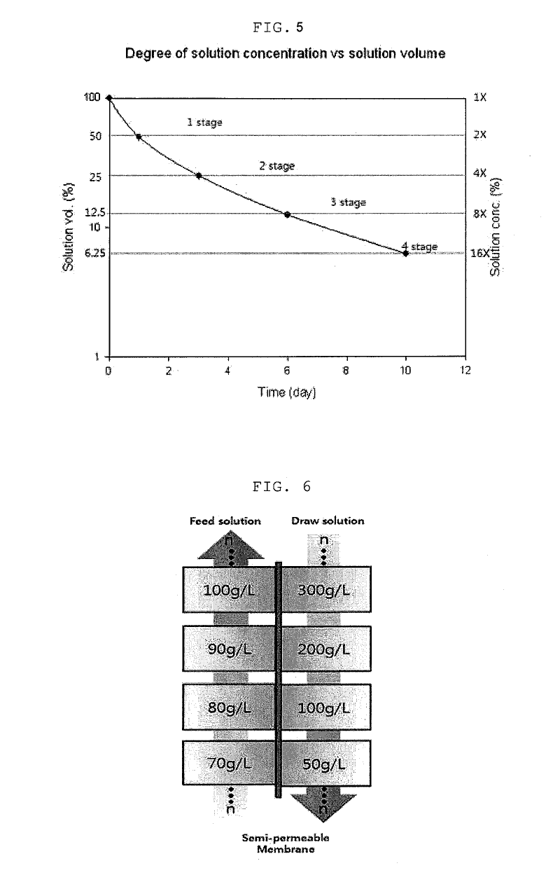

FIG. 5 is a graphic diagram showing the changes in solution concentration and volume during an osmosis process as a function of time. In FIG. 5, the Y-axis indicates the volume of solution (%), and the X-axis indicates concentration time. When 50% of the volume of water in solution is removed, the concentration of the solute in the solution becomes twice (2×) the concentration of the solute in the original solution (X; 100% volume). When 50% of the volume of water in the remaining solution (50% volume) is further removed, the volume of water in the resulting solution corresponds to 25% of the volume of water in the original solution, and the concentration of the solute in the resulting solution becomes four times (4×) the concentration of the solute in the resulting solution (100% volume).

Meanwhile, the present inventors predicted that, if the forward osmosis is carried out in multiple stages, the osmotic pressure of the draw chamber can be more effectively used.

As shown in FIG. 6, when n units are subjected to countercurrent forward osmosis (FO), they can concentrate fermentations broth in a more efficient and economical manner, because a draw solution having a lower water concentration (corresponding to an osmolyte) can be used to a fermentation broth having a lower product concentration, and a draw solution having a higher water concentration can used to concentrate a fermentation broth having a higher water concentration.

Thus, in the present invention, each of the feed chamber and the draw chamber preferably consists of multiple stages (see FIG. 6). When each chamber consists of multiple stages as such, the high-osmotic pressure solution in the draw chamber can be more effectively used compared to when the fermentation broth is concentrated in a single stage for a long time.

The present inventors predicted that, if the pH or temperature property of a feed solution (fermentation broth) is changed or an osmolyte is progressively introduced into the draw chamber, the fermentation broth can be more efficiently concentrated. Thus, in the present invention, this prediction was confirmed.

In the present invention, the fermentation broth may have a pH of 2-13 and a temperature of about 0-100° C. at which water maintains a liquid phase. For example, other solute/solvent mixtures may have a temperature out of the above temperature range. The osmolyte is preferably progressively introduced into the draw chamber, because it can severely deteriorate the efficiency of forward osmosis when there is a significant difference in osmotic pressure between the feed chamber and the draw chamber.

In the present invention, after the forward osmosis process has been carried out, the osmolyte in the draw chamber is preferably transferred to a solute regeneration system 40 in which it is regenerated for reuse.

The solute regeneration system 40 serves to separate the osmolyte from the draw solution using energy such as solar heat or waste heat.

### EXAMPLES

Hereinafter, the present invention will be described in further detail with reference to examples. It will be obvious to those skilled in the art that these examples are illustrative purposes only and are not to be construed to limit the scope of the present invention.

### Example 1

### Concentration of Succinic Acid

A test for concentration of succinic acid using forward osmosis was carried out. A succinic acid solution used as a feed solution was a fermentation product resulting from an actual fed-batch fermentation process, and a forward osmosis reactor comprising a forward osmosis membrane (HTI, USA) made of cellulose triacetate was used. A draw solution used in the test was 30 wt % NaCl (feed solution: 300 mL, and draw solution: 300 mL). The pH of the succinic acid solution used in the test was adjusted to 8-9 by ammonia water.

TABLE 1

| | Volume | Concen- | | | | | |
|---|---|---|---|---|---|---|---|
| | of | tration | | | | | |
| | succinic | of | pH of | Volume | Flow | Re- | |
| | acid | succinic | succinic | of | rate of | jection | |
| Time | solution | acid | acid | effluent | effluent | ratio | Re- |
| (hr) | (mL) | (g/L) | solution | (mL) | (mL/hr) | (%) | marks |
| 0 | 300 | 67.42 | 8.82 | 0 | 0 | 0 | Start |
| 16.5 | 195 | 100.97 | 8.83 | 105 | 6.36 | 149.75 | |
| 28.5 | 164 | 124.24 | 8.84 | 35 | 1.23 | 184.27 | |
| 40.5 | 144 | 147.62 | 8.41 | 17 | 0.41 | 218.95 | |
| 88 | 129 | 153.82 | 8.33 | 15 | 0.17 | 228.14 | |

As a result, as can be seen in Table 1 above, water could be removed from the succinic acid solution using the forward osmosis process, thereby increasing the concentration of succinic acid in the residue. The concentration of succinic acid could be twice or more from 67.42 g/L to 153.82 g/L.

### Example 2

### Concentration of Total Volatile Fatty Acids

A test for concentration of total volatile fatty acids using forward osmosis was carried out. Total volatile fatty acids used in the test were acetic acid:propionic acid:butyric acid (6:1:3) which generally result from an acid fermentation process. A forward osmosis reactor comprising a forward osmosis membrane (HTI, USA) made of cellulose triacetate was used in the test. A draw solution used in the test was 30 wt % NaCl (feed solution: 300 mL, and draw solution: 300 mL). The pH of the total volatile fatty acids used in the test was adjusted to 9 by ammonia water.

TABLE 2

| | | Concen- | | | | | |
|---|---|---|---|---|---|---|---|
| | Volume | tration | | | | | |
| | of | of | | | | | |
| | volatile | volatile | | Volume | Flow | Re- | |
| | fatty | fatty | pH of | of | rate of | jection | |
| Time | acid | acid | feed | effluent | effluent | ratio | Re- |
| (hr) | (mL) | (g/L) | solution | (mL) | (mL/hr) | (%) | marks |
| 0 | 300 | 93 | 9.46 | 0 | 0 | 0 | Start |
| 4 | 276 | 102.29 | 9.34 | 24 | 6.00 | 110.00 | |
| 17 | 228 | 120.83 | 9.22 | 48 | 2.82 | 129.94 | |
| 29 | 199 | 129.61 | 9.14 | 29 | 1.00 | 139.38 | |
| 46 | 181 | 147.75 | 9.02 | 18 | 0.39 | 158.88 | |

As can be seen in Table 2 above, water could be removed from the volatile fatty acid-containing solution using the forward osmosis process, thereby increasing the concentration of the volatile fatty acids in the residue. The concentration of the volatile fatty acids could be 1.58 times or more increased from 93 g/L to 147 g/L at 46 hours after the start of the test.

### Example 3

### Concentration of Microalga

A test for concentration of microalga using forward osmosis was carried out. Microalga (Nannochloropsis oculata, Utex, USA) was grown in F/2 media at 26° C. for 2 weeks in the presence of light and CO₂, and then used as a feed solution in the test. A forward osmosis reactor comprising a forward osmosis membrane (HTI, USA) made of cellulose triacetate was used in the test. A draw solution used in the test was 20 wt % NaCl (feed solution: 350 mL, and draw solution: 350 mL).

The optical density (concentration) of the microalga was measured at 680 nm using UV-Vis spectrometry.

TABLE 3

| | Volume of | Concen- | | Flow | | |
|---|---|---|---|---|---|---|
| | microalga- | tration | | rate | | |
| | containing | of | Volume of | of | | |
| Time | solution | microalga | effluent | effluent | Rejection | Re- |
| (hr) | (mL) | (g/L) | (mL) | (mL/hr) | ratio (%) | marks |
| 0 | 350 | 0.705 | 0 | 0 | 0 | Start |
| 10 | 280 | 0.820 | 70 | 7.05 | 116.6 | |

As can be seen in Table 3, water could be removed from the microalga-containing solution using the forward osmosis process, thereby increasing the concentration of the microalga in the residue. The concentration of the volatile fatty acids could be 1.16 times or more increased 10 hours after the start of the test.

### Example 4

### Concentration of Protein

A test for concentration of protein using forward osmosis was carried out. Protein used in a feed solution was a 62-88% egg albumin solution having an initial concentration of 1 g/L. A forward osmosis reactor comprising a forward osmosis membrane (HTI, USA) made of cellulose triacetate was used in the test. A draw solution used in the test was 30 wt % NaCl (feed solution: 300 mL, and draw solution: 300 mL).

TABLE 4

| | Volume | | | | | |
|---|---|---|---|---|---|---|
| | of | Concen- | Volume | Flow | | |
| | protein | tration | of | rate of | | |
| Time | solution | of protein | effluent | effluent | Rejection | |
| (hr) | (mL) | (g/L) | (mL) | (mL/hr) | ratio (%) | Remarks |
| 0 | 300 | 1 | 0 | 0 | 0 | Start |
| 4 | 282.15 | 1.07 | 17.85 | 4.46 | 107 | |
| 8 | 269.25 | 1.11 | 30.75 | 3.84 | 111.4 | |
| 12 | 259.95 | 1.15 | 40.05 | 3.34 | 115.4 | |

As can be seen in Table 4 above, water could be removed from the protein solution using the forward osmosis process, thereby increasing the concentration of albumin in the residue. The concentration of albumin could be 1.15 times or more increased from 1 g/L to 1.15 g/L at 12 hours after the start of the test.

### Example 5

### Concentration of Amino Acid

A test for concentration of amino acid using forward osmosis was carried out. Amino acid used in the test was the water-soluble amino acid L-tyrosine. A forward osmosis reactor comprising a forward osmosis membrane (HTI, USA) made of cellulose triacetate was used in the test. A draw solution used in the test was 30 wt % NaCl (feed solution: 300 mL, and draw solution: 300 mL).

TABLE 5

| | Volume of | | | | | |
|---|---|---|---|---|---|---|
| | L- | Concen- | | Flow | | |
| | Tyrosine- | tration | Volume | rate | Re- | |
| | containing | of | of | of | jection | |
| Time | solution | L-Tyrosine | effluent | effluent | ratio | |
| (hr) | (mL) | (g/L) | (mL) | (mL/hr) | (%) | Remarks |
| 0 | 300 | 0.69 | 0 | 0 | 0 | Start |
| 3 | 255.56 | 0.81 | 44.44 | 14.81 | 117.4 | |

As can be seen in Table 5 above, when the solution containing L-tyrosine was concentrated using the forward osmosis process, the concentration of L-tyrosine could be about 1.17 times increased from 0.69 g/L to 0.81 g/L at 3 hours after the start of the test.

### Example 6

### Concentration of Sugar

A test for concentration of sugar using forward osmosis was carried out. Sugar used in the test was the polysaccharide sucrose. A forward osmosis reactor comprising a forward osmosis membrane (HTI, USA) made of cellulose triacetate was used in the test. A draw solution used in the test was 30 wt % NaCl (feed solution: 300 mL, and draw solution: 300 mL).

TABLE 6

| | Volume of | | | | | |
|---|---|---|---|---|---|---|
| | sucrose- | Concen- | Volume | Flow | | |
| | containing | tration | of | rate of | | |
| Time | solution | of sucrose | effluent | effluent | Rejection | |
| (min) | (mL) | (g/L) | (mL) | (mL/hr) | ratio (%) | Remarks |
| 0 | 300 | 302.2 | 0 | 0 | 0 | Start |
| 100 | 193 | 469.7 | 107 | 64.2 | 155.4 | |

As can be seen in Table 6 above, when the solution containing sucrose was concentrated using the forward osmosis process, the concentration of sucrose could be about 1.5 times increased from 0302.2 g/L to 469.7 g/L at 100 minutes after the start of the test.

### Example 7

### Comparison of Co-Current Connection with Counter-Current Connection

Although multiple-stage reactors mainly adopt counter-current connection in FIG. 6, the efficiencies of co-current connection and counter-current connection according to the number of separators were verified in the following manner.

Volatile fatty acid (VFA) used in Example 2 was concentrated in each of multiple-stage reactors which adopt co-current connection and counter-current connection by varying numbers of separators as shown in Table 7 below.

When inlet solution (volatile fatty acid) is concentrated four times at an osmotic pressure of 20 bar, the osmotic pressure of the resulting outlet solution is 80 bar, the osmotic pressure of solution inlet in the draw chamber is 200 bar, and the osmotic pressure of solution outlet from the draw chamber is 114 bar.

In the forward osmosis process, because only water moves from the feed chamber to the draw chamber, the product (VFA) in the feed chamber becomes gradually thicker (increase in osmotic pressure), but the osmolyte (NaCl) in the draw chamber becomes gradually thinner (decrease in osmotic pressure). As a result, the difference in pressure between the two chambers decreases, leading to a decrease in the efficiency of concentration. The comparison of efficiency between processes can be expressed as the membrane area required to concentrate the fermentation broth four times (see Table 7)

TABLE 7

| | | Co-current | |
|---|---|---|---|
| Number of | Counter-current | (parallel current) | |
| separators | connection area | connection area | Area remarks: 1000 units |
| 1 | 29.2 | 29.2 | Number of separators: 1 |
| 2 | 13.8 | 19.0 | Pressure difference: |
| 3 | 11.5 | 15.8 | 200/1.75 − 20/0.25 = |
| 4 | 10.7 | 14.2 | 114.3 − 80 = 34.3 bar |
| | | | Required area = |
| | | | 1000/34.3 = 29.15 |
| | | | units(area) |

The process factors used in the calculation were as follows: the concentration of water (mixed volatile fatty acid) input in the feed chamber, cfi=35 g/L (osmotic pressure: 20 bar); the concentration of water outlet from the feed chamber, cfo=140 g/L (80 bar); the osmotic pressure of solution (NaCl) inlet in the draw chamber, πdi=200 bar; the osmotic pressure of solution (NaCl) outlet from the draw chamber πdo: 200/(1+amount of water that moved due to forward osmosis). Ultimately, in order for the feed solution to be concentrated four times, 75% of the solvent (water) in the feed chamber should move to the draw chamber, in which the flux of water outlet from the feed chamber (qfo) is 25% of the flux of water inlet in the feed chamber (qfi), and the final flux of solution in the draw chamber is 175%.

Calculation example: qfi=1.0 L/h, qfo=0.25 L/h (πfo=80 bar), qdi=1.0 L/h, qdo=1.75 L/h (πdo=114.3 bar). The difference in osmotic pressure between the feed chamber and the draw chamber=114.3−80=34.3 bar. Accordingly, the membrane area required in the single-stage system=1000 units/[114.3−80]=29.2 area units.

As can be seen in Table 7 above, the multiple-stage forward osmosis system for concentration is highly efficient compared to the single-stage system, and the counter-current connection is more economical than the co-current connection. In other words, the counter-current connection requires a smaller membrane area compared to the co-current connection in the same system.

As described above, the concentration of low titer fermentation broth using reverse osmosis or an extraction solvent is economically unsuitable because a large amount of energy is consumed or the extraction solvent is expensive. However, the method of concentrating a fermentation broth using forward osmosis according to the present invention can maximize the concentration of the fermentation broth while minimizing energy consumption and operating cost, and thus can contribute to the industrialization of new technology.

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

In addition, a person skilled in the art will appreciate that, in addition to NaCl, ammonia carbamate may be used in the draw chamber, and that, in addition to the embodiment employing the difference in osmotic pressure between the two chamber, embodiments employing the change in pressure by external pressure (ΔP), and changes in pH and temperatures, will also be preferable.

What is claimed is:

1. A method of concentrating a fermentation broth using forward osmosis, the method comprising: introducing the fermentation broth and an osmolyte into a feed chamber and a draw chamber, respectively, which are included in a concentration system and are divided from each other by a forward osmosis membrane, and subjecting the introduced fermentation broth to forward osmosis, thereby concentrating the fermentation broth in the feed chamber.

2. The method of claim 1, wherein the forward osmosis membrane is permeable to water or a material having a molecular weight lower than that of a material to be concentrated, which is contained in the fermentation broth in the feed chamber, such that the water or lower molecular weight material is transferred to the draw chamber.

3. The method of claim 1, wherein the fermentation broth comprises a material selected from the group consisting of microorganisms, microbial primary metabolites, microbial secondary metabolites, secreted microbial proteins, microbial biotransformations, plant cells, animal cells, and mixtures thereof.

4. The method of claim 1, wherein the osmolyte is selected from the group consisting of an NaCl-containing solution, an ammonia carbamate-containing solution, a waste solution having a high osmotic pressure, and an MgCl₂-containing solution.

5. The method of claim 1, wherein the forward osmosis is performed by a process selected from the group consisting of a batch process, a continuous process and a pressure process using external pressure.

6. The method of claim 5, wherein the batch process corresponds to a case in which the feed chamber and the draw chamber have no mass exchange therebetween although they can exchange energy with the outside, the continuous process corresponds to a case in which the feed chamber and the draw chamber have energy and mass exchange with the outside, and the pressure process using external pressure comprises applying a pressure to the feed chamber or applying a vacuum to the draw chamber to cause a difference in pressure between the two chambers.

7. The method of claim 5, wherein the batch process is performed until the difference in head pressure (ΔP) is equal to the difference in osmotic pressure (Δπ), the continuous process is performed until an equilibrium state is reached in which the difference in head pressure (ΔP) becomes zero and the difference in osmotic pressure (Δπ) becomes zero, and the pressure process using external pressure is performed until the difference in pressure induced by applying external pressure (ΔPex) is equal to the difference in osmotic pressure (Δπ).

8. The method of claim 1, wherein each of the feed chamber and the draw chamber consists of multiple stages.

9. The method of claim 1, wherein the fermentation broth has a pH of 2-13 and a temperature in which water is maintained in the liquid state.

10. The method of claim 1, wherein the osmolyte is progressively introduced into the draw chamber to efficiently maintain the difference in osmotic pressure between the feed chamber and the draw chamber.

11. The method of claim 1, wherein after the forward osmosis has been performed, the osmolyte in the draw chamber is transferred to a solute regeneration system in which it is in turn regenerated for reuse.
